(19) United States
(12) Patent Application Publication
(10) Pub. No.: US 2016/0082437 A1
(43) Pub. Date: Mar. 24, 2016

(54) COVER WITH MICRO-CONTAINER INTERFACE FOR COVERING A MICROFLUIDIC GAP

(71) Applicant: TECAN TRADING AG, Mannedorf (CH)

(72) Inventors: Thomas PERROUD, Lexington, MA (US); Daniel HOFFMEYER, San Jose, CA (US); Adrian SAGER, Mannedorf (CH); Anne KOPF-SILL, Portola Valley, CA (US)

(73) Assignee: TECAN TRADING AG, Mannedorf (CH)

(21) Appl. No.: 14/943,520

(22) Filed: Nov. 17, 2015

Related U.S. Application Data
(63) Continuation-in-part of application No. 14/335,027, filed on Jul. 18, 2014.

(51) Int. Cl. B01L 3/00

(52) U.S. Cl. CPC B01L 3/502792; B01L 3/50273; B01L 3/502715; B01L 2300/165; B01L 2400/0427; B01L 2300/041; B01L 2200/06; B01L 2200/027; B01L 2300/046

(57) ABSTRACT

A cover (10) for use in a digital microfluidics system (16) for manipulating samples in liquid portions or droplets. The digital microfluidics system (16) includes a first substrate (18) with an array of electrodes (24) and a central control unit (20) for controlling the selection and for providing a number of the electrodes with voltage for manipulating liquid portions or droplets by electrowetting. A working gap (30) with a gap height is located parallel to the array of electrodes (24) and in-between first and second hydrophobic surfaces (26,28) that face each other at least during operation of the digital microfluidics system (16).

### RELATED APPLICATIONS

This patent application is a continuation in part application of the U.S. application Ser. No. 14/335,027 filed on Jul. 18, 2014. The entire disclosure of this US application is incorporated herein by explicit reference for any purpose.

### FIELD OF TECHNOLOGY

The present invention relates to a cover for use in a digital microfluidics system for manipulating samples in liquid portions or droplets. Typically, such a digital microfluidics system comprises a first substrate and a central control unit. The first substrate comprises an array of electrodes and the central control unit is in operative connection to these electrodes for controlling the selection of individual electrodes thereof and for providing a number of said electrodes with voltage for manipulating liquid portions or droplets by electrowetting. In such a digital microfluidics system typically, a working gap with a gap height is located parallel to the array of electrodes and in-between first and second hydrophobic surfaces. The two hydrophobic surfaces are facing each other at least during operation of the digital microfluidics system.

This technical field generally relates to the control and manipulation of liquids in a small volume, usually in the micro- or nanoscale format. In digital microfluidics, a defined voltage is applied to electrodes of an electrode array, so that individual droplets are addressed (electrowetting). For a general overview of the electrowetting method, please see Washizu, IEEE Transactions on Industry Applications, Volume 34, No. 4, 1998, and Pollack et al., Lab chip, 2002, Volume 2, 96-101. Briefly, electrowetting refers to a method to move liquid droplets using arrays of microelectrodes, preferably covered by a hydrophobic layer. By applying a defined voltage to electrodes of the electrode array, a change of the surface tension of the liquid droplet, which is present on the addressed electrodes, is induced. This results in a remarkable change of the contact angle of the droplet on the addressed electrode, hence in a movement of the droplet. For such electrowetting procedures, two principle ways to arrange the electrodes are known: using one single surface with an electrode array for inducing the movement of droplets or adding a second surface that is opposite a similar electrode array and that provides at least one ground electrode. A major advantage of the electrowetting technology is that only a small volume of liquid is required, e.g. a single droplet. Thus, liquid processing can be carried out within considerably shorter time. Furthermore, the control of the liquid movement can be completely under electronic control resulting in automated processing of samples.

### RELATED PRIOR ART

Automated liquid handling systems are generally well known in the art. An example is the Freedom EVO® robotic workstation from the present applicant (Tecan Schweiz AG, Seestrasse 103, CH-8708 Männedorf, Switzerland). These automated systems are larger systems that are not designed to be portable and typically require larger volumes of liquids (microliter to milliliter) to process.

A device for liquid droplet manipulation by electrowetting using one single surface with an electrode array (a monoplanar arrangement of electrodes) is known from the U.S. Pat. No. 5,486,337. All electrodes are placed on a surface of a carrier substrate, lowered into the substrate, or covered by a non-wettable surface. A voltage source is connected to the electrodes. The droplet is moved by applying a voltage to subsequent electrodes, thus guiding the movement of the liquid droplet above the electrodes according to the sequence of voltage application to the electrodes.

An electrowetting device for microscale control of liquid droplet movements, using an electrode array with an opposing surface with at least one ground electrode is known from U.S. Pat. No. 6,565,727 (a biplanar arrangement of electrodes). Each surface of this device may comprise a plurality of electrodes. The two opposing arrays form a gap. The surfaces of the electrode arrays directed towards the gap are preferably covered by an electrically insulating, hydrophobic layer. The liquid droplet is positioned in the gap and moved within a non-polar filler fluid by consecutively applying a plurality of electric fields to a plurality of electrodes positioned on the opposite sites of the gap.

Containers with a polymer film for manipulating samples in liquid droplets thereon are known from WO 2010/069977 A1: a biological sample processing system comprises a container for large volume processing and a flat polymer film with a lower surface and a hydrophobic upper surface. The flat polymer film is kept at a distance to a base side of the container by protrusions. This distance defines at least one gap when the container is positioned on the film. A substrate supporting at least one electrode array is also disclosed as well as a control unit for the liquid droplet manipulation instrument. The container and the film are reversibly attached to the liquid droplet manipulation instrument either separately or stably connected to each other in the form of a disposable cartridge. The system enables displacement of at least one liquid droplet from the at least one well through a channel of the container onto the hydrophobic upper surface of the flat polymer film and above the at least one electrode array. The liquid droplet manipulation instrument is accomplished to control a guided movement of said liquid droplet on the hydrophobic upper surface of the flat polymer film by electrowetting and to process there the biological sample.

The use of such an electrowetting device for manipulating liquid droplets in the context of the processing of biological samples is also known from the international patent application published as WO 2011/002957 A2. There, it is disclosed that a droplet actuator typically includes a bottom substrate with the control electrodes (electrowetting electrodes) insulated by a dielectric, a conductive top substrate, and a hydrophobic coating on the bottom and top substrates. The cartridge may include a ground electrode, which may be replaced by a hydrophobic layer, and an opening for loading samples into the gap of the cartridge. Interface material (e.g. a liquid, glue or grease) may provide adhesion of the cartridge to the electrode array.

Disposable cartridges for microfluidic processing and analysis in an automated system for carrying out molecular diagnostic analysis are disclosed in WO 2006/125767 A1 (see US 2009/0298059 A1 for an English translation). The cartridge is configured as a flat chamber device (with about the size of a check card) and can be inserted into the system. A sample can be pipetted into the cartridge through a port and into processing channels.

Droplet actuator structures are known from the international patent application WO 2008/106678. This document particularly refers to various wiring configurations for electrode arrays of droplet actuators, and additionally discloses a two-layered embodiment of such a droplet actuator which comprises a first substrate with a reference electrode array separated by a gap from a second substrate comprising control electrodes. The two substrates are arranged in parallel, thereby forming the gap. The height of the gap may be established by spacer. A hydrophobic coating is in each case disposed on the surfaces which face the gap. The first and second substrate may take the form of a cartridge, eventually comprising the electrode array.

From US 2013/0270114 A1, a digital microfluidics system for manipulating samples in liquid droplets within disposable cartridges is known. The disposable cartridge comprises a bottom layer, a top layer, and a gap between the bottom and top layers. The digital microfluidics system comprises a base unit with at least one cartridge accommodation site that is configured for taking up a disposable cartridge, at least one electrode array comprising a number of individual electrodes and being supported by a bottom substrate, and a central control unit for controlling selection of the individual electrodes of said at least one electrode array and for providing these electrodes with individual voltage pulses for manipulating liquid droplets within said cartridges by electrowetting.

A disposable cartridge having a body with at least one compartment configured to hold therein processing liquids, reagents or samples (a disposable cartridge for microfluidics system) is known from US 2013/0134040 A1, incorporated herein by explicit reference. The disposable cartridge further comprises a bottom layer with a first hydrophobic surface that is configured as a working film for manipulating samples in liquid droplets thereon. Further comprised is a top layer with a second hydrophobic surface that is attached to a lower surface of the body. The bottom layer is configured as a flexible film that is sealingly attached to the top layer along a circumference of the flexible bottom layer. The disposable cartridge thus being devoid of a spacer that is located between the flexible bottom layer and the top layer for defining a particular distance between said first hydrophobic surface and said second hydrophobic surface.

A digital microfluidics system configured for substantially removing or suspending magnetically responsive beads from or in liquid portions or droplets (magnetic conduits in microfluidics) is known from PCT/US2015/048141. Said digital microfluidics system comprises a number or array of individual electrodes attached to a first substrate, wherein a first hydrophobic surface is located on said individual electrodes.

Further comprised is a central control unit in operative contact with said individual electrodes. In the first substrate of the microfluidics system and below said individual electrodes there is located at least one magnetic conduit that is configured to be backed by a backing magnet, said at least one magnetic conduit being located in close proximity to individual electrodes. In this system, magnetically responsive beads are removed from droplets on a working surface in digital microfluidics by means of the integration of the magnetic conduit into the PCB of a digital microfluidics device.

### OBJECTS AND SUMMARY OF THE PRESENT INVENTION

Electrowetting is a versatile approach to automate complex assays for life sciences and diagnostic point-of-care markets. The integration of an electrowetting platform with a robotic liquid handler enables the delivery of samples and reagents inside the fluidic chamber (gap) of a disposable cartridge used in electrowetting in a digital microfluidics system whenever needed and with a large range of volumes possible (2-1000 μl). However, such approach is not optimal for point-of-care diagnostic markets for the reasons below:

One problem relies on reagents and samples containment to prevent contamination. Traditional liquid handlers rely on a centralized high-performance positive-displacement pump for the aspiration and the dispensing of liquids either via a syringe (e.g. Tecan Cavro® Centris Pump) or a piston (e.g. Tecan Cavro® Air Displacement Pipettor). Certain assays are highly sensitive to minute contamination: for example, single-molecule assays or assays requiring a large number of cycles during PCR amplification. Minute contamination can come from variable sources such as the creation of an aerosol during liquid dispensing or during the ejection of disposable tips, imperfect washing of fixed tips, contamination of system fluid in a syringe pump, or open samples/reagents vials that need to be accessible to the liquid handler. These assays often require processes to be separated onto different instruments or even in different laboratory rooms.

Another problem relies on instrument footprint, weight and cost. Traditional liquid handlers have a robotic arm to move the liquid handler between the reagent vials and the cartridge. This configuration requires a non-negligible amount of space and prevents the instrument from being compact. The weight and cost of 3-axis motors, metallic supports, driving belts, and other mechanical components are not really compatible with the concept of a point-of-care instrument. Also, a centralized high-performance syringe pump represents an unnecessary cost to the instrument because the precision of the reagent dispensing is controlled by electrowetting and only approximate volumes of reagents need to be injected into the electrowetting cartridge.

Therefore, interfacing with a robotic liquid handler is a problem in the state of the art.

Lyophilization is a dehydration process commonly used for the preservation of perishable reagents during transportation and long-term storage at room temperature. Lyophilized reagents could be stored inside the fluidic chamber of a disposable cartridge used in electrowetting and re-solubilized by a buffer solution whenever needed. However, the lack of physical barriers inside the fluidic chamber can result in lyophilized beads shifting within the disposable cartridge especially during transportation and ending up being at the wrong location or, even worse, contaminating unwanted areas of the disposable cartridge. The implementation of containment features within the disposable cartridge used in electrowetting would involve complex manufacturing processes and thus a less cost-effective consumable. Additionally, not all reagents can be lyophilized (e.g. alcohols) and would need to be loaded by the user whenever needed thus removing the convenience of a true walkaway solution.

Therefore, embedding lyophilized reagents into the fluidics chamber of a disposable cartridge used in electrowetting is a problem in the state of the art.

It is further a problem in the state of the art that certain reagents (e.g. enzymes, fluorophores, HRP substrate) need to be kept under specific conditions (low temperature, protected from light) prior to their usage to remain fully functional or to prevent the formation of unwanted byproduct. A further problem relies on that non-polar reagents (ethanol, isopropanol) cannot be exposed to the filler fluid for long periods of time especially at high temperatures in order to prevent their slow dissolution. Further, fluid capacity (≦30 μl) for storing individual reagents inside the cartridge is limited by the height of the fluidic chamber and may not be sufficient if repeated operations are needed (e.g. wash buffer). Reagent containment is of paramount importance when dealing with assays highly sensitive to minute contamination. Complex and tedious assays often require a large number of reagents (≧15) which, if loaded manually, could lead to improper loading and thus assay failure.

It is an object of the present invention to suggest a cover for use in a digital microfluidics system resolving problems in the state of the art.

This object is achieved in that it is proposed that the cover introduced at the beginning further comprises on one side the second hydrophobic surface and on another side at least one micro-container interface for safe introducing into and/or withdrawing of liquids from the gap. Moreover, the at least one micro-container interface comprises at least one cone, the inner surface thereof being formed such to provide a sealing form fit contact with an outer surface of an inserted micro-container nozzle, by which a liquid is transferrable through a fluidic access hole formed into the cover and interconnecting each cone and the gap.

It is another object of the present invention to suggest a micro-container resolving problems in the state of the art.

This object is achieved by a micro-container for use in a digital microfluidics system for manipulating samples in liquid portions or droplets. The micro-container comprises a tube, a nozzle with an aperture, and a piston sealingly guided inside the tube for dispensing or aspirating liquid via the nozzle of the micro-container. The outer surface of the nozzle of the micro-container is formed such to provide a sealing form fit contact with an inner surface of a cone comprised by a micro-container interface of a cover as herein disclosed.

It is another object of the present invention to suggest a means adapted to proper and easily accommodate at least one micro-container.

This object is achieved by a manifold comprising at least one micro-container receptacle adapted to accommodate a micro-container as herein disclosed.

It is another object of the present invention to suggest a method of introducing into and/or withdrawing liquid from a gap of a digital microfluidics system.

In a first aspect, this object is achieved by a method of introducing liquid into a gap of a digital microfluidics system for manipulating samples in liquid portions or droplets; the digital microfluidics system comprising a first substrate and a central control unit, wherein said first substrate comprises an array of electrodes, and wherein said central control unit is in operative connection to said electrodes for controlling the selection of individual electrodes thereof and for providing a number of said electrodes with voltage for manipulating liquid portions or droplets by electrowetting; in said digital microfluidics system, a working gap with a gap height is located parallel to the array of electrodes and in-between first and second hydrophobic surfaces; the two hydrophobic surfaces facing each other at least during operation of the digital microfluidics system. The method comprises the steps of:
(a) placing a cover on the first substrate of the digital microfluidics system, the cover comprising on one side the second hydrophobic surface and on another side at least one micro-container interface; said at least one micro-container interface comprising at least one cone with an inner surface and at least one fluidic access hole formed into the cover and interconnecting each cone and the gap;
(b) providing an essentially uniform height of the gap between said first and second hydrophobic surfaces;
(c) inserting a nozzle of at least one micro-container filled with liquid into at least one cone of the micro-container interface of the cover;
(d) creating a sealing form fit contact between the inner surface of the at least one cone of the micro-container interface and an outer surface of the nozzle of the inserted at least one micro-container; and
(e) dispensing liquid from the at least one micro-container into the gap via the at least one fluidic access hole formed in the cover.

In a second aspect, this object is achieved by a method of withdrawing liquid from a gap of a digital microfluidics system for manipulating samples in liquid portions or droplets, the digital microfluidics system comprising a first substrate and a central control unit, wherein said first substrate comprises an array of electrodes, and wherein said central control unit is in operative connection to said electrodes for controlling the selection of individual electrodes thereof and for providing a number of said electrodes with voltage for manipulating liquid portions or droplets by electrowetting; in said digital microfluidics system, a working gap with a gap height is located parallel to the array of electrodes and in-between first and second hydrophobic surfaces; the two hydrophobic surfaces facing each other at least during operation of the digital microfluidics system. The method comprises the steps of:
(a) placing a cover on the first substrate of the digital microfluidics system, the cover comprising on one side the second hydrophobic surface and on another side at least one micro-container interface; said at least one micro-container interface comprising at least one cone with an inner surface and at least one fluidic access hole formed into the cover and interconnecting each cone and the gap;
(b) providing an essentially uniform height of the gap between said first and second hydrophobic surfaces;
(c) inserting the nozzle of at least one micro-container into at least one cone of the micro-container interface of the cover,
(d) creating a sealing form fit contact between the inner surface of the at least one cone of the micro-container interface and an outer surface of the nozzle of the inserted at least one micro-container; and
(e) aspirating liquid from the gap into the at least one micro-container via the at least one fluidic access hole formed into the cover.

Additional and inventive features and preferred embodiments and variants of the cover, the micro-container, the manifold and the methods derive from the respective dependent claims.

Advantages of the present invention comprise:
The invention provides micro-containers allowing to be prepackaged with reagents. Micro-containers already filled with reagents advantageously reduce user intervention.
The cover of the digital microfluidics system comprises at least one micro-container interface designed to easily interface with the nozzle of the micro-container.
The at least one micro-container interface comprises a cone allowing to sealingly connect the micro-container to the cover.
The form fit connection created between the cone of the cover and the nozzle of the micro-container allows to minimize dead volume.
A plurality of micro-containers can be assembled into the manifold to simplify their installation onto the digital microfluidics system as a whole. Therefore, the number of operations required from the user during instrument initialization can be reduced.
The manifold can be equipped with passive or active thermal troughs to keep the reagents inside the micro-container at a specific temperature either passively (e.g. ice pack) or actively (e.g. circulating coolant, thermoelectric coolers).
The digital microfluidics system can be provided with an actuation mechanism that can inject the reagents contained inside the micro-containers into the gap by positive displacement or recover liquid from the gap by negative displacement. The injection of liquid into the gap occurs by positive displacement when the piston of the micro-container is pushed down by a mechanical actuation of the actuation mechanism, and the aspiration of liquid into the micro-container occurs by negative displacement when the piston is pulled up by a respective mechanical actuation. Therefore, advantageously no user operation is required.
The high capacity of the micro-container advantageously allows consecutive partial injections of reagents into the electrowetting cartridge.
The micro-container can withdraw liquid from the electrowetting cartridge to act as waste storage or for the recovery of treated samples that require further analysis onto a different instrument.
The injection of reagents pre-loaded into the micro-containers can be computer controlled. Therefore, advantageously, individual or multiple simultaneous injections can be performed whenever required.
The volumes of liquid injected into the electrowetting cartridge can vary between 1 μl-200 μl, more preferably 10 μl-100 μl.
Advantageously, a bolus of air can be added at the tip of the micro-container to isolate the reagent or its chemical components from the filler fluid during operation. This bolus of air is injected with the reagent into the cartridge when needed.
The micro-container can be part of a collection kit to collect the sample (e.g. blood from a finger prick). The micro-dimension of the container is an advantageous key element for the proper loading of the sample into the container, e.g. via capillary action. Alternatively, fluids can be loaded by withdrawing the piston.
The micro-container contains lyophilized reagents that can be re-solubilized by aspirating buffer solution brought to the fluidic access hole via electrowetting. Advantageously, such pre-packaged reagents would not require special handling (e.g. temperature) during transportation and storage.

### BRIEF INTRODUCTION OF THE DRAWINGS

Aspects and preferred embodiments according to the present invention are described with the help of the attached schematic drawings that show selected and exemplary embodiments of the present invention without narrowing the scope and gist of this invention. It is shown in:

FIG. 1A a cross sectional view of a first embodiment of a cover with an introduced micro-container in a partial view;

FIG. 1B a cross sectional view of a second embodiment of a cover with an introduced micro-container in a partial view;

FIG. 2 cross sectional views of micro-containers having different sizes;

FIG. 3 a perspective view of a first embodiment of a manifold equipped with a plurality of micro-containers;

FIG. 4 a perspective view of a second embodiment of a manifold equipped with a plurality of micro-containers;

FIG. 5 a perspective view of the second embodiment of the manifold with an array of caps to be attached;

FIG. 6 a perspective view of a first embodiment of a trough;

FIG. 7 a perspective view of the first embodiment of the trough equipped with the manifold as shown in FIG. 4 or 5;

FIG. 8 a perspective view of first aspect of a plate-like rigid cover equipped with a manifold in which a plurality of micro-containers are inserted, each connected to mechanical actuators;

FIG. 9 a cross sectional view of the first aspect as shown in FIG. 8.

### DETAILED DESCRIPTION OF THE PRESENT INVENTION

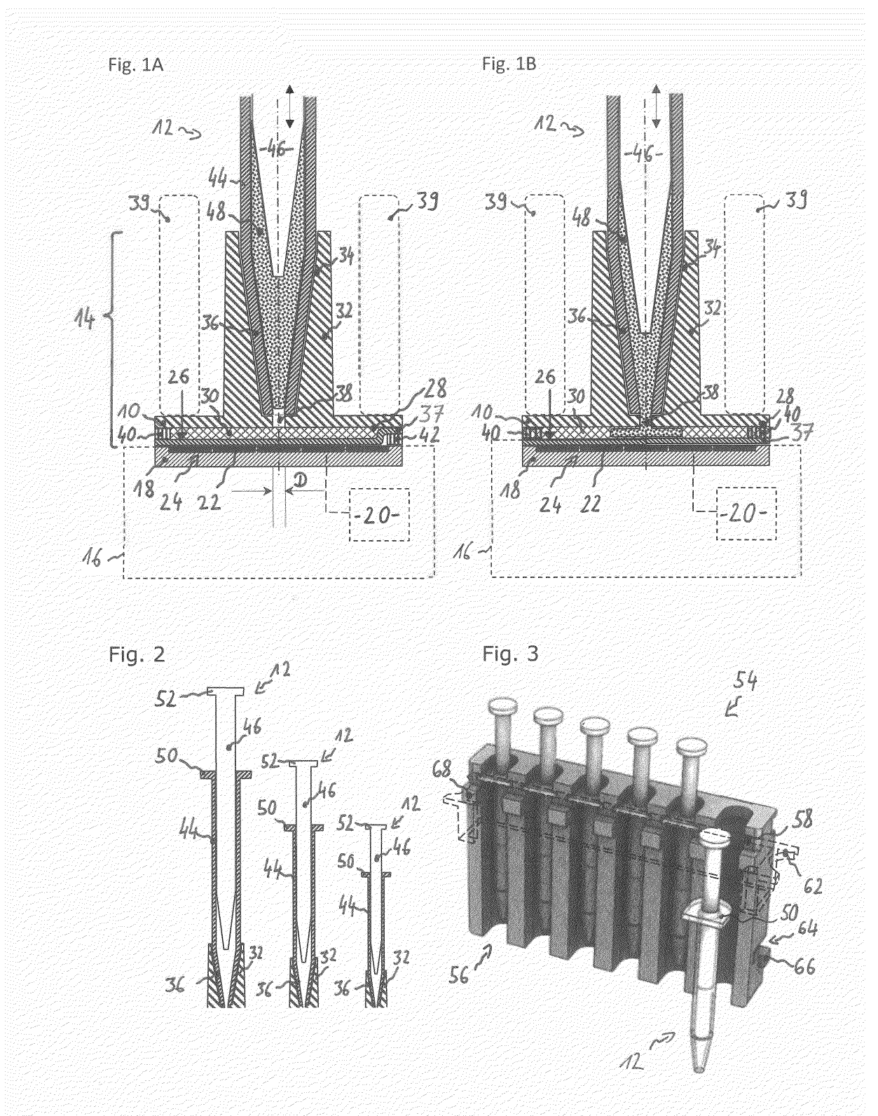

FIG. 1A shows a cross sectional view of a first embodiment of a cover 10 with an introduced micro-container 12 in a partial view. In particular, FIG. 1A illustrates a disposable cartridge 14 for use in a digital microfluidics system 16 for manipulating samples in liquid portions or droplets, only a small part of the disposable cartridge 14 being visualized though. The digital microfluidics system 16 comprises a first substrate 18 and a central control unit 20 for controlling the selection of individual electrodes 22 of an electrode array 24 comprised by the first substrate 18. The first substrate 18 is comprised by the digital microfluidics system 16. The central control unit 20 is configured for providing a number of said electrodes 22 with voltage or rather individual voltage pulses for manipulating liquid portions or droplets by electrowetting. The disposable cartridge 14 comprises a first hydrophobic surface 26 and the cover 10, the bottom of which is provided with a second hydrophobic surface 28.

In the following, the first hydrophobic layer 26 can be referred as hydrophobic working layer.

According to the first embodiment, it is to be noted that the first hydrophobic surface 26 is comprised by the disposable cartridge 14. The second hydrophobic surface 28 is comprised by the cover 10, the latter being part of a disposable cartridge 14. In any case however, the two hydrophobic surfaces 26,28 are facing each other at least during operation of the digital microfluidics system 16.

In the first embodiment as shown in FIG. 1A, the first and second hydrophobic surfaces 26,28 are both comprised by the disposable cartridge 14 configured to be positioned on the array of electrodes 24 of the first substrate 18. Both hydrophobic surfaces 26,28 are facing each other at least during operation of the digital microfluidics system 16 and are separated or separable in essentially parallel planes by a gap 30 with a gap height. The cover 10 comprises on one side the second hydrophobic surface 28 and on another side at least one micro-container interface 32 for safe introducing into and/or withdrawing of liquids from the gap 30. Said at least one micro-container interface 32 comprises at least one cone 34, wherein the inner surface thereof being formed such to provide a sealing form fit contact with an outer surface of an inserted micro-container nozzle 36.

In the first embodiment as shown in FIG. 1A, the cover 10 as well as the first and second hydrophobic surfaces 26,28 are comprised by the disposable cartridge 14, which is configured to be positioned on the array of electrodes 24 of the first substrate 18. The disposable cartridge 14 comprises a working film 37 with the first hydrophobic surface 26 and the cover 10 comprises the second hydrophobic surface 28. Said second hydrophobic surface 28 is separated or separable from said first hydrophobic surface 26 by said gap 30. The working film 37, if placed on the digital microfluidics system 16, comprises a backside that touches an uppermost surface of the first substrate 18 of the digital microfluidics system 16. A liquid portion is transferrable via said micro-container nozzle 36 and through a fluidic access hole 38 formed into the cover 10 and inter-connecting each cone 34 and the gap 30. The diameter D of the aperture of the micro-container nozzle 36 can equal the diameter of the fluidic access hole 38 and preferably measures ≦1.0 mm or ≦0.5 mm.

It is preferred that the digital microfluidics system 16 comprises at least one clamping means 39 for establishing good mechanical contact between the disposable cartridge 14 and the uppermost surface of the substrate 18. In doing so, the cover 10 is clamped or rather held in place on the uppermost surface of the first substrate 18 by means of the least one clamping means 39 of the digital microfluidics system 16. It is further preferred that at least a part of the at least one clamping means 39 of the digital microfluidics system 16 is configured to press onto a free area of the cover 10 of the disposable cartridge 14 that is properly placed on the substrate 18 of the digital microfluidics system 16.

According to the invention as depicted in FIGS. 1A and 1B, a method of introducing liquid 48 into the gap 30 of the digital microfluidics system 16 for manipulating samples in liquid portions or droplets is provided, wherein the digital microfluidics system 16 comprises a first substrate 18 and a central control unit 20, wherein said first substrate 18 comprises an array of electrodes 24, and wherein said central control unit 20 is in operative connection to said electrodes for controlling the selection of individual electrodes 22 thereof and for providing a number of said electrodes with voltage for manipulating liquid portions or droplets by electrowetting. In said digital microfluidics system 16, a working gap 30 with a gap height is located parallel to the array of electrodes 24 and in-between the first and second hydrophobic surfaces 26,28; wherein the two hydrophobic surfaces 26,28 are facing each other at least during operation of the digital microfluidics system 16. The method comprises a first step of placing the cover 10 on the first substrate 18 of the digital microfluidics system 16, wherein the cover 10 comprises on one side the second hydrophobic surface 28 and on another side the at least one micro-container interface 32, wherein said at least one micro-container interface 32 comprises at least one cone 34 with an inner surface and at least one fluidic access hole 38 formed into the cover 10 and inter-connecting each cone 34 and the gap 30. A second step comprises providing an essentially uniform height of the gap 30 between said first and second hydrophobic surfaces 26,28. A third step comprises inserting the nozzle 36 of the at least one micro-container 12 filled with the liquid 48 into the at least one cone 34 of the micro-container interface 32 of the cover 10. A forth step comprises creating a sealing form fit contact between the inner surface of the cone 34 of the micro-container interface 32 and the outer surface of the nozzle 36 of the inserted micro-container 12. A fifth step comprises dispensing the liquid 48 from the at least one micro-container 12 into the gap 30 via the fluidic access hole 38 formed in the cover 10.

The method can further comprise the step of clamping the placed cover 10 on the first substrate 18 by means of the at least one clamping means 39 of the digital microfluidics system 16.

According to the first embodiment, in a first aspect as depicted on the left side of FIG. 1A, the cover 10 of the disposable cartridge 14 is configured rigid or flexible. At least one spacer 40 is attached to the cover 10 such to sealingly enclose the gap 30. Said spacer 40 defines the height of the gap 30 between the first and second hydrophobic surfaces 26,28 of the disposable cartridge 14. Further, the spacer 40 permanently separates the first and second hydrophobic surfaces 26,28 from each other. Preferably the spacer 40 is located close to the outer circumference of the disposable cartridge 14; however, additional and intermediately located spacers (not shown) may enable the utilization of a less rigid and/or thinner cover 10 with its first hydrophobic surface 26. While not shown, the cover 10 of the disposable cartridge 14 can be configured flexible.

In the first embodiment of the invention, in the first aspect as shown on the left side of FIG. 1A, a method of introducing liquid into the gap 30 of the digital microfluidics system 16 is provided, wherein the disposable cartridge 14 comprises a working film 37 with the first hydro-phobic surface 26 and the cover 10 comprising the second hydrophobic surface 28, wherein the cover 10 of the disposable cartridge 14 is configured rigid or flexible, at least one spacer 40 being attached to the cover 10, the second hydrophobic surface 28 being separated from said first hydrophobic surface 26 by said gap 30, wherein said working film 37 comprises a backside that is configured to touch an uppermost surface of the first substrate 18 of the digital microfluidics system 16. This method further comprises a sixth step of sealingly enclosing the gap 30 with the spacer 40. The method further comprises a seventh step of defining with the spacer 40 the height of the gap 30 between the first and second hydrophobic surfaces 26,28 of the disposable cartridge 14, and permanently separating the first and second hydrophobic surfaces 26,28. Further, the method comprises an eighth step of positioning the disposable cartridge 14 on the array of electrodes 24 of the first substrate 18 of the digital microfluidics system 16.

According to the first embodiment, in a second aspect as shown on the right side of FIG. 1A, the cover 10 of the cartridge 14 is rigid and the working film 37 of the cartridge 14 is flexible. In other words, the working film 37 of the disposable cartridge 14 is configured as a flexible sheet that spreads on the uppermost surface of the substrate 18 of the digital microfluidics system 16. For doing so, the digital microfluidics system 16 preferably comprises a vacuum source (not shown) for establishing an underpressure in an evacuation space between the uppermost surface of the substrate 18 and the backside of the working film 37 of the disposable cartridge 14. Further, at least one gasket 42 can be attached to the cover 10 and outside of the gap 30 for separating said first and second hydrophobic surfaces 26,28 when creating the underpressure between the backside of the working film 37 and the uppermost surface of the first substrate 18 of the digital microfluidics system 16. In a non-shown alternative, the gasket 42 can be attached to the uppermost surface of the substrate 18. Moreover, providing a rigid gasket 42 as a loose insert is also possible. However, in this second aspect of the embodiment, the gasket 42 is outside of the gap 30 and also on the outside of the working film 37. The gasket 42 seals an evacuation space against the environment when the underpressure is established inside the evacuation space using the vacuum source of the digital microfluidics system 16. The flat spreading of the working film 37 provides an essentially uniform height of the gap 30, wherein this gap height is defined by the height of the gasket 42. In this second aspect, the disposable cartridge 14 is devoid of a spacer (refer to first aspect) that would need to be located inside the gap 30 between the working film 37 and the second hydrophobic surface 28 of the rigid cover 10.

In the first embodiment of the invention, in the second aspect as shown on the right side of FIG. 1A, a method of introducing liquid into the gap 30 of the digital microfluidics system 16 is provided, wherein the cover 10 is comprised by a disposable cartridge 14, the disposable cartridge 14 comprising a working film 37 with the first hydrophobic surface 26 and the cover 10 comprises the second hydrophobic surface 28, the cover 10 of the disposable cartridge 14 is configured rigid and the working film 37 of the disposable cartridge 14 is configured flexible; wherein at least one gasket 42 being attached to the cover 10 and outside of the gap 30 for separating said first and second hydrophobic surfaces 26,28. The method further comprises a sixth step of positioning the disposable cartridge 14 on the array of electrodes 24 of the first substrate 18 of the digital microfluidics system 16. The method further comprises a seventh step of creating an underpressure between the backside of the working film 37 and the uppermost surface of the first substrate 18 of the digital microfluidics system 16. Further, the method comprises an eighth step of spreading the working film 37 on the first substrate 18 of the digital microfluidics system 16 and establish the gap height.

In the scope of the present invention, a “sample” is defined in its broadest sense. A “sample” may be present in or introduced into e.g. an aqueous liquid portion or droplet for example as a biopolymer, e.g. such as nucleic acid or protein; a biomonomer, e.g. such as nucleic base or amino acid; as ions in buffers; as solvents; and as reagents. These “samples” are listed for illustration only but not for limiting interpretation of the expression “sample”.

As mentioned above, according to the first embodiment of the present invention as shown in FIG. 1A, the cover 10 comprises on one side the second hydrophobic surface 28 and on the other side at least one micro-container interface 32 (only one being shown here) for safe introducing into and/or withdrawing of liquids from the gap 30. Such introducing or withdrawing preferably is carried out by the nozzle 36 of the micro-container 12 via the fluidic access hole 38 formed into the cover 10. Said at least one micro-container interface 32 comprises the cone 34, wherein the inner surface thereof formed such to provide a sealing form fit contact with an outer surface of the inserted nozzle 36 of the micro-container 12, by which nozzle 36 liquid is transferred through the fluidic access hole 38 formed into the cover 10 and interconnecting each cone 34 and the gap 30. This cone 34 also is configured to prevent the nozzle 36 from touching the first hydrophobic surface 26. The micro-container 12 further comprises a tube 44 formed integrally with the nozzle 36. The tube 44 receives a piston 46 allowing movement thereof in an axially direction. The micro-container 12 is filled with a liquid 48. The micro-container can be adapted to transfer a sample to the digital microfluidics system, said sample preferably is selected from body fluids, e.g. from the group comprising blood, saliva, urine, and feces.

FIG. 1B shows a cross sectional view of a second embodiment of a cover 10 with an introduced micro-container 12 in a partial view. In this Figure, same components as shown in FIG. 1A are given similar reference signs. In particular, the second embodiment depicted in FIG. 1B differs from the first embodiment as depicted in FIG. 1A in that the first hydrophobic surface 26 is not comprised by a cartridge Like the embodiment shown in FIG. 1A, the second hydrophobic surface 28 is comprised by the cover 10. The cover 10 is configured as a rigid plate and to be accommodated on the first substrate 18. The cover 10 comprises the spacer 40 for separating said first and second hydrophobic surfaces 26,28 when accommodating the cover 10 on the first substrate 18 of the digital microfluidics system 16. Alternatively, the spacer 40 can be comprised by the first substrate 18. As a further option, the spacer 40 can be provided separately; in this option, the spacer 40 is affixed to neither the cover 10 nor the first substrate 18. This separate spacer 40 is formed as a single part allowing to be sandwiched between the first substrate 18 or rather the first hydrophobic surface 26 and the cover 10. In doing so, in setting up the microfluidics system 16, first the spacer 40 is placed onto the substrate 18 or rather the first hydrophobic surface 26. Afterwards, the cover 10 is placed onto the spacer 40.

The spacer 40 can be formed such to separate a plurality of working areas in the gap 30 provided between the first and second hydrophobic surfaces 26, 28. In this option, the spacer 40 can be formed as a planar component comprising recesses in areas which act as working areas in the gap 30 provided between the first and second hydrophobic surfaces 26, 28. Hence, the spacer 40 can act itself as a barrier used to delimit respective working areas. This barrier feature of the spacer 40 allows to prevent mixture of liquids and to prevent from cross-contaminations during handling. Additionally, the spacer 40 still acts to support the cover 10. The cover 10 is placed on the first hydrophobic surface 26 with the gap 30 interposed. The gap 30 can be filled with liquid 48 introduced from the micro-container 12. Otherwise, liquid 48 contained in said gap 30 can be withdrawn into the micro-container 12.

In a second aspect of the second embodiment, the first hydrophobic surface 26 is comprised by a working film 37 that is reversibly placeable on the first substrate 18. Further, the second hydrophobic surface 28 is comprised by the cover 10 that is configured as a rigid plate and to be accommodated on the working film 37. In this aspect, the cover 10 comprises the spacer 40 for separating said first and second hydrophobic surfaces 26,28 when accommodating the cover 10 on the working film 37 which is placed on said first substrate 18 of the digital microfluidics system 16. In a further option, the spacer 40 can be comprised by the working film 37. Furthermore, the spacer 40 can be formed as a single component, acting itself as a barrier used to delimit at least two working areas onto the working film 37.

According to a first aspect in the second embodiment as depicted in FIG. 1B on the left side, in a method of introducing liquid into the gap 30 of the digital microfluidics system 16, said first hydrophobic surface 26 is irremovably comprised by said first substrate 18 and the second hydrophobic surface 28 is comprised by said cover 10 that is configured as a rigid plate. This method further comprises a sixth step of accommodating the cover 10 on the first substrate 18, and a seventh step of separating said first and second hydrophobic surfaces 26,28 by a spacer 40 that is separately provided. In an alternative, the spacer 40 can be comprised by the cover 10. In a further alternative, the spacer 40 can be comprised by the first substrate 18 of the digital microfluidics system 16.

According to a second aspect in the second embodiment as depicted in FIG. 1B on the right side, in a method of introducing liquid into a gap 30 of a digital microfluidics system 16, said first hydrophobic surface 26 being comprised by a working film 37 that is reversibly placeable on said first substrate 18 and the second hydrophobic surface 28 being comprised by said cover 10 that is configured as a rigid plate. The method comprises a sixth step of placing the working film 37 on the first substrate 18 of the digital microfluidics system 16. The method further comprises a seventh step of accommodating the cover 10 on the first substrate 18; and an eighth step of separating said first and second hydrophobic surfaces 26,28 by a spacer 40 that is separately provided or that is comprised by the cover 10 or by the working film 37.

In the first and second embodiments as depicted in FIGS. 1A and 1B, a method of withdrawing liquid 48 from the gap 30 of the digital microfluidics system 16 for manipulating samples in liquid portions or droplets is provided, wherein the digital microfluidics system 16 comprises the first substrate 18 and the central control unit 20, wherein said first substrate 18 comprises the array of electrodes 24, and wherein said central control unit 20 is in operative connection to said electrodes for controlling the selection of individual electrodes 22 thereof and for providing a number of said electrodes with voltage for manipulating liquid portions or droplets by electrowetting. In said digital microfluidics system 16, the working gap 30 with a gap height is located parallel to the array of electrodes 24 and in-between the first and second hydrophobic surfaces 26,28, wherein the two hydrophobic surfaces 26,28 facing each other at least during operation of the digital microfluidics system 16. The method comprises the steps of: (a) placing the cover 10 on the first substrate 18 of the digital microfluidics system 16, the cover 10 comprising on one side the second hydrophobic surface 28 and on another side at least one micro-container interface 32; said at least one micro-container interface 32 comprising at least one cone 34 with an inner surface and at least one fluidic access hole 38 formed into the cover 10 and interconnecting each cone 34 and the gap 30; (b) providing an essentially uniform height of the gap 30 between said first and second hydrophobic surfaces 26,28; (c) inserting the nozzle 36 of at least one micro-container 12 into at least one cone 34 of the micro-container interface 32 of the cover 10; (d) creating a sealing form fit contact between the inner surface of the at least one cone 34 of the micro-container interface 32 and an outer surface of the nozzle 36 of the inserted at least one micro-container 12; and (e) aspirating liquid from the gap 30 into the at least one micro-container 12 via the at least one fluidic access hole 38 formed into the cover 10.

In the first embodiment, in a first aspect as depicted in FIG. 1A on the left side, a method of withdrawing liquid 48 from the gap 30 of the digital microfluidics system 16 is provided, wherein the cover 10 is comprised by the disposable cartridge 14, the disposable cartridge 14 comprises the working film 37 with the first hydrophobic surface 26 and the cover 10 comprises the second hydrophobic surface 28, wherein the cover 10 of the disposable cartridge 14 being configured rigid or flexible, wherein at least one spacer 40 being attached to the cover 10, the second hydrophobic surface 28 being separated or separable from said first hydrophobic surface 26 by said gap 30, said working film 37 comprising a backside that is configured to touch an uppermost surface of the first substrate 18 of the digital microfluidics system 16. The method further comprises the steps of: (f) sealingly enclosing the gap 30 with the spacer 40; (g) defining with the spacer 40 the height of the gap 30 between the first and second hydrophobic surfaces 26,28 of the disposable cartridge, and permanently separating the first and second hydrophobic surfaces 26,28; and (h) positioning the disposable cartridge 14 on the array of electrodes 24 of the first substrate 18 of the digital microfluidics system 16.

In the first embodiment, in a second aspect as depicted in FIG. 1A on the right side, a method of withdrawing liquid 48 from the gap 30 of the digital microfluidics system 16 is provided, wherein the cover 10 is comprised by the disposable cartridge 14, wherein the disposable cartridge 14 comprises the working film 37 with the first hydrophobic surface 26 and the cover 10 comprises the second hydrophobic surface 28, wherein the cover 10 of the disposable cartridge 14 is configured rigid and the working film 37 of the disposable cartridge 14 is configured flexible; wherein at least one gasket 42 is attached to the cover 10 and outside of the gap 30 for separating said first and second hydrophobic surfaces 26,28. The method further comprises the steps of: (f) positioning the disposable cartridge 14 on the array of electrodes 24 of the first substrate 18 of the digital microfluidics system 16; (g) creating an underpressure between the backside of the working film 37 and the uppermost surface of the first substrate 18 of the digital microfluidics system 16; and (h) spreading the working film 37 on the first substrate 18 of the digital microfluidics system 16 and establishing the gap height.

In the second embodiment as depicted in FIG. 1B, in a first aspect, a method of withdrawing liquid 48 from the gap 30 of the digital microfluidics system 16 is provided, wherein said first hydrophobic surface 26 is irremovably comprised by said first substrate 18 and the second hydrophobic surface 28 is comprised by said cover 10 that is configured as a rigid plate. The method further comprises the steps of: (f) accommodating the cover 10 on the first substrate 18; and (g) separating said first and second hydrophobic surfaces 26,28 by a spacer 40 that is separately provided or that is comprised by the cover 10 or by the first substrate 18 of the digital microfluidics system 16.

In the second embodiment as depicted in FIG. 1B, in a second aspect, a method of withdrawing liquid 48 from the gap 30 of the digital microfluidics system 16 is provided, wherein said first hydrophobic surface 26 is comprised by a working film 37 that is reversibly placeable on said first substrate 18 and the second hydrophobic surface 28 is comprised by said cover 10 that is configured as a rigid plate. The method further comprises the steps of: (f) placing the working film 37 on the first substrate 18 of the digital micro-fluidics system 16; (g) accommodating the cover 10 on the first substrate 18; and (h) separating said first and second hydrophobic surfaces 26,28 by a spacer 40 that is separately provided or that is comprised by the cover 10 or by the working film 37.

FIG. 2 depicts cross sectional views of micro-containers 12 different in size. The micro-container 12 is a disposable plastic micro-syringe comprising the tube 44 with the nozzle 36 formed integrally. The nozzle 36 comprises an aperture having a predefined diameter. The tube 44 sealingly receives the piston 46 which is guided inside the tube 44 in an axial direction for dispensing or aspirating liquid via the nozzle 36 of the micro-container 12. The outer surface of the nozzle 36 is designed to create a sealing form fit contact with an inner surface of a cone comprised by the micro-container interface 32 (refer to FIGS. 1A, 1B) of the cover 10. This feature allows to minimize dead volume. The micro-container 12 can be made out of a cost-effective biocompatible material to be disposed of after a single use. In further examples, the micro-container 12 can be made out of polypropylene, polystyrene, polyethylene, polycarbonate, cyclic olefin copolymers (TOPAS), or cyclic olefin polymers (Zeonor). The micro-container 12 can be a high-capacity container having a capacity of 1000 μl, 500 μl, 100 μl, for example. The micro-dimension of the aperture at the distal end of the nozzle 36 is ≦1 mm or ≦0.5 mm, for example, in order to prevent leakage of solutions out of the micro-container 12 because surface tension effects can dominate over hydrostatic pressure. The micro-container 12 can be made opaque to protect reagents sensitive to light from possible degradation (e.g. fluorophores, HRP substrate). In an example, the micro-container 12 is pre-filled with a liquid selected from a group comprising reagents, oil, buffers and samples.

In order to be gripped by a manifold, preferably an outer surface of the tube 44 of the micro-container 12 is provided with a first gripping portion 50. In order to be gripped by a robot or an actuator, the distal end of the piston 46 of the micro-container 12 is provided with a second gripping portion 52. The first and second gripping portions 50,52 preferably comprise an outer rim projecting radially from the outer surfaces of the tube 44 and piston 46, respectively. In operation, applying a force to the first and second gripping portions 50,52 in a direction such to move them to each other causes dispensing liquid from the micro-container 12, and in a direction such to move them from each other causes aspirating liquid into the micro-container 12.

Further advantages of the micro-container 12 are as follows. The high capacity of the micro-container 12 allows consecutive partial injections of reagents into a disposable cartridge (refer e.g. FIG. 1A). The micro-container 12 can withdraw liquid from the gap of the disposable cartridge such to act as waste storage or for the recovery of treated samples that require further analysis onto a different instrument. Further, the injection of liquids, e.g. reagents pre-loaded into the micro-containers 12, is computer controlled so that individual or multiple simultaneous injections can be performed whenever required. Furthermore, the volumes of liquid injected into the electrowetting cartridge can vary between 1 μl-200 μl, more preferably 10 μl-100 μl. A bolus of air can be added at the tip of the nozzle 36 of the micro-container 12 to isolate the reagent or its chemical components from a filler fluid during operation. This bolus of air can be injected with the reagent into the disposable cartridge if necessary. The micro-container 12 can be part of a collection kit in order to collect a sample (e.g. blood from a finger prick). The micro-dimension of the micro-container 12 allows proper loading of a sample into the micro-container 12 via capillary action. The micro-container 12 can contain lyophilized reagents that can be re-solubilized by aspirating buffer solution brought to a fluidic access hole of a disposable cartridge. Advantageously, such pre-packaged reagents would not require special handling (e.g. temperature) during transportation and storage.

FIG. 3 is a perspective view of a first embodiment of a manifold 54 equipped with a plurality of micro-containers 12 (refer to FIG. 2). For the sake of a better overview, a single micro-container 12 (the right one in the Figure) is shown removed from the manifold 54. The manifold 54 comprises a plurality of elongated micro-container receptacles 56 aligned to each other in parallel. Each of the receptacles 56 comprises elongated recesses formed into the manifold 54, continuously. Each of said receptacles 56 is adapted to receive a micro-container 12. In the exemplary embodiment as depicted in FIG. 3, the micro-containers 12 are inserted into or rather coupled to the receptacles 56 by moving the first gripping portion 50 of each micro-container 12, which first gripping portion 50 comprises an outer rim projecting radially from the outer surfaces of the tube, into a respective groove 58 formed into each of the receptacles 56 of the manifold 54. In doing so, each of the micro-containers 12 can be received in and coupled to the manifold 54 in a releasable manner, at least in an axial direction of the micro-container 12.

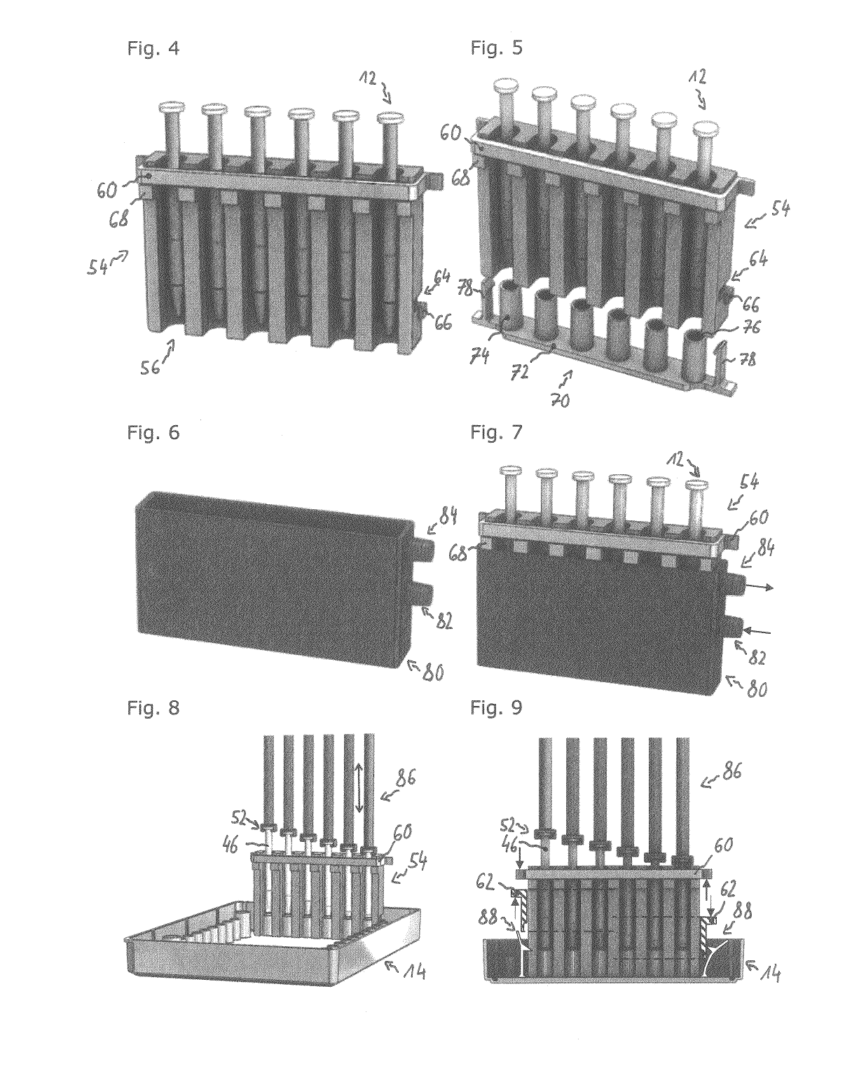

In the exemplary embodiment shown in FIG. 3, at least one rim part of the first gripping portion 50 of the micro-container 12 is formed planar or rather flattened. This flattened portion is formed such to align with respective planar portions of the manifold 54 located in a region adjacent to the loaded micro-container 12. In other words, the flattened portion of the first gripping portion 50 of the micro-container 12, once inserted into the receptacle 56, aligns with wall portions of the manifold 54. The manifold 54 is adapted to receive a clip 60 attachable to the manifold 54 such to engage the planar rim part of the first gripping portion 50 of respective micro-containers 12 received in the receptacles 56 (refer e.g. to FIGS. 4 and 5). In doing so, the aligned portion of the manifold 54 can be engaged by means of the clip 60 attachable to the manifold 54, as shown in FIGS. 4 and 5. The clip 60 is adapted to engage the planar rim part of the first gripping portion 50 of at least one micro-container 12 received in one of the receptacles 56. In other words, the micro-containers 12 are secured to the manifold 54 by means of the clip 60. In a first aspect, attachment of the clip 60 to the manifold 54 at least on one side of the clip 60 is a snap-fit connection.

In the examples shown e.g. in FIGS. 4 and 5, attachment of the clip 60 to the manifold 54 on both sides of the clip 60 is a snap-fit connection. In a non-shown further example, the clip 60 can be hinged to the manifold 54 on one lateral side thereof, wherein attachment of the clip 60 to the manifold 54 on the other side of the clip 60 is a snap-fit connection. In this example, the clip 60 is pivotally supported to the manifold 54 on one side. The other side or rather the non-hinged part of the clip 60 can be provided with a snap-fit means, e.g. a latch, adapted to engage a periphery portion of the manifold 54. This feature preferably allows biased engagement of the micro-containers 12 in the manifold 54 by proper pushing or rather urging the micro-containers 12 into the grooves 58 of the manifold 54 (refer to FIG. 3). In this example, said sleeve can abut against or rather be seated on ledges (refer to ledges 68 in FIGS. 3-5) formed on the front side of the manifold 54. A detailed description of the ledges will be given below. In order to allow the micro-containers 12 to be released from the manifold 54, the sleeve can be removed from the manifold 54 by pulling the sleeve from the manifold 54 in an upward direction.

Returning back to FIG. 3, it is preferred that the manifold 54 further comprises a releasing lever 62 movably attached to the periphery of the manifold 54 such to be moved in an upwards and downwards direction. Said releasing lever 62 is for releasing latches (refer to FIGS. 5 and 9) snapped into a recess 64 formed into lateral wall portions of the manifold 54. Said recess 64 can be formed elongated, recessed into the manifold 54 from the rear of the manifold 54, for example. A region of the manifold 54 beneath the recess 64 can be provided with a protrusion 66. The protrusion 66 can be formed such to not fully overlap the elongated recess 64. A more detailed description of the recess 64 and the protrusion 66 will be provided in the following.

The releasing lever 62 can be snapped onto the periphery of the manifold 54 from the rear such to be clamped between endmost lateral sides of the front side and the whole back side of the manifold 54. In other words, the releasing lever 62 is mounted to the manifold 54 such to still maintain the front side of the manifold 54 fully exposed to the outside. This feature still allows the micro-containers 12 to be inserted into and removed from the receptacles 56. Further, the releasing lever 62 is clamped onto the manifold 54 in a region between the protrusions 66 and ledges 68 formed on partition walls between respective adjacent receptacles 56 on the front side of the manifold 54. A more detailed description of the ledges 68 will be provided in the following. The releasing lever 62 is movable up and down in relation to the periphery of the manifold 54 in a range delimited by the protrusions 66 and the ledges 68. Therefore, unintentional drop-off of the releasing lever 62 can be prevented.

As mentioned above, the manifold 54 allows reception of a plurality of micro-containers 12 (e.g., in the embodiment shown in FIGS. 3 and 4, the manifold 54 receives a total of six micro-containers 12). Therefore, individually loading a disposable cartridge (refer to FIG. 1A) with single micro-containers 12 can be avoided. Hence, advantageously, the number of operations required from the user during instrument initialization is reduced. Further, while not shown, the manifold 54 loaded with the micro-containers 12 can comprise a registration feature to prevent improper installation onto the disposable cartridge, for example. Furthermore, while not shown, the manifold 54 can contain a sonication device to create homogeneous solutions prior to injection into the electrowetting cartridge. Such solutions can consist of suspensions of particles, and more specifically, magnetic beads. Sonication can also be used to disrupt cell membrane.

FIG. 5 is a perspective view of the manifold 54 as shown in FIGS. 3 and 4 as well as a linear array of caps 70 for attachment thereof to the bottom of the manifold 54. This attachment can be a releasable attachment. The linear array of caps 70 comprises a support 72 and a plurality of caps 74 mounted on the support 72, the number of the caps 74 equals the number of micro-containers 12 insertable into the manifold 54. In other words, the manifold 54 is adapted to receive at least one cap 74 attachable to the manifold 54 at a bottom side thereof, the at least one cap 74 being formed such to sealingly engage a nozzle of a micro-container 12 received in the manifold 54.

Each of the caps 74 of the linear array of caps 70 is formed such to sealingly engage a nozzle of a micro-container 12 respectively received in the manifold 54. In doing so, if the caps 70 are attached to the manifold 54, a cone 76 comprised by each of the caps 74 receives a respective nozzle of a micro-container 12. The inner surface of each cone 76 is formed such to provide a sealing form fit contact with an outer surface of the nozzle of a respective micro-container 12 inserted in the manifold 54. In other words, the cones 74 reliably plug the micro-containers 12 against leakage of liquids. The caps 70 can be added to the respective nozzles of individual micro-containers 12 after reagents loading thereof. Therefore, accidental cross-contaminations or leakage of reagent into the environment during transportation or storage can be avoided.

As mentioned above, the attachment of the linear array of caps 70 to the manifold 54 at the bottom side thereof preferably is a releasable attachment, in particular a snap-fit connection. In doing so, the support 72 comprises latches 78 for releasable attachment of the support 72 to the manifold 54 and for temporary sealing form fit contact with an outer surface of nozzles of the micro-containers 12 received in the manifold 54 if the caps 74 are attached to the manifold 54. The latches 78 are provided at outermost lateral sides of the support 72. Said latches 78 each protrude upwards from an upper surface of the support 72. Each of the latches 78 is adapted to snap into the recesses 64 formed into the lateral sides of the manifold 54 (refer to the above). If snapped-in, having regard to the example shown in FIG. 5, rear side portions of the latches 78 abut against the protrusions 66, respectively, formed into the lateral sides of the manifold 54, as well (refer to the above). Further, front side portions of distal ends of the ledges 78 snapped into the recesses 64, respectively, abut against respective faces of the recesses 64. This feature reliably prohibits lateral movement as well as pivotal movement of the linear array of caps 70 and the manifold 54 in relation to each other, if the linear array of caps 70 is attached to the manifold 54. Hence, a reliable and very firm connection is provided.

FIG. 6 is a perspective view of an exemplary trough 80 adapted to receive a manifold 54 by inserting it from the above, and FIG. 7 is a perspective view of the first embodiment of the trough 80 as shown in FIG. 6 equipped with the manifold 54 as shown e.g. in FIG. 4. The trough 80 is capable of keeping the reagent inside the micro-containers 12 inserted into the manifold 54 at a specific temperature either passively (e.g. ice pack) or actively (e.g. circulating coolant, thermoelectric coolers). Once inserted into the trough 80, the bottom portions of the ledges 68 formed on the partition wall portions of the manifold 54 on the front side thereof abut against the upper rim of the trough 80. As can be seen in the FIGS. 6 and 7, the trough 80, on a right lateral side thereof, is provided with a feeding connection 82 allowing applying tempering liquid into the interior of the trough 80 and an outlet connection 84 allowing withdrawing of the tempering liquid from the interior of the trough 80 into which a part of the micro-containers 12 accommodated in the manifold 54 are reaching. Hence, reliable cooling of liquid inserted into the micro-containers 12 is achieved.

Preferably, an assembly comprising the manifold 54 equipped with the micro-containers 12, the nozzles of which are sealed by means of the linear array of caps 70, is received into the trough 84. This arrangement allows to keep liquids inside the micro-containers 12 at a specific temperature as well as to prevent leakage of the liquids out of the micro-containers or rather mixture of liquids leaked from different micro-containers 12.

FIG. 8 is a perspective view of a first aspect of the disposable cartridge 14 (refer to FIG. 1A) equipped with a manifold 54 in which a plurality of micro-containers 12 are received, and FIG. 9 is a cross sectional view of the first aspect as shown in FIG. 8. In the shown aspect, each of the micro-containers 12 is connected to a respective one of a plurality of mechanical actuators 86. In particular, each mechanical actuator 86 is connected to a respective micro-container 12 via its second gripping portion 52 (e.g. refer to FIG. 2). For example, the mechanical actuators 86 form part of or interface with a robotic arm (not shown). The arrangement shown in FIGS. 8 and 9 allows for on-demand injection of liquids into e.g. the disposable cartridge 14. In this arrangement, the injection of liquid into the disposable cartridge 14 is performed by positive displacement when the piston 46 of the micro-container 12 is pushed down by mechanical actuation of a respective one of the mechanical actuators 86. Otherwise, the aspiration of liquid from the disposable cartridge 14 into the micro-container 12 is performed by negative displacement when the piston 46 of the micro-container 12 is pulled up by mechanical actuation of a respective one of the mechanical actuators 86. Therefore, advantageously, no user operation is required and automatic processing of microfluidic assays is enabled. The integration of the disposable cartridge 14 with the robotic liquid handler allows the delivery of samples and reagents into the gap of the disposable cartridge 14 whenever needed and with a large range of volumes possible (e.g. 2-1000 μl).

The manifold 54 can be mounted to the cover 10, e.g. of a disposable cartridge 14 by means of a removable snap-fit connection. As best shown in FIG. 9, the cover 10 of a disposable cartridge 14 preferably is equipped with latches 88, which are adapted to engage recesses formed into the lateral wall of the manifold 54 (refer to latches 78 shown in FIG. 5 and recesses 64 shown in FIGS. 3-5). Once the latches 88 are snapped into the recesses, removal of the manifold 54 from the disposable cartridge 14 is blocked.

In order to disengage the snap-fit connection, the releasing lever 62 (also refer to FIG. 3), which is movably mounted to the manifold 54, can be pulled downwards, as schematically shown on the right side of the FIG. 9. In doing so, a bottom edge of the releasing lever 62 engages a sloped portion formed on the upper end portion of each of the latches 88. A further movement of the releasing lever 62 downwards results to the bottom edge of the releasing lever 62 further slides along the sloped upper end portion of each of the latches 88, which sliding consecutively urges the latches 88 outwards or rather in a direction away from the manifold 54 or rather out of the respective recesses thereof. In turn, this outward urging moves the latches 88 out of engagement with the recess. Once the latches 88 are totally disengaged or rather released from the respective recesses, the manifold 54 is free to be removed from a cover 10, e.g. from a disposable cartridge 14 by simply pulling the manifold 54 upwards while the disposable cartridge 14 remains in place. It is to be noted that reinstallation of the manifold 54 to the disposable cartridge 14 requires the releasing lever 62 to be moved upwards, previously, as schematically shown on the left side of the FIG. 9.

Alternatively and departing from the embodiments shown in the Figures, the manifold 54 (or a number of manifolds 54) can be irremovably attached to or can be integrated into a cover 10 of all herein disclosed varieties, e.g. a cover 54 of a disposable cartridge 14 (not shown).

Reference numbers

| | |
|---|---|
| 10 | cover |
| 12 | micro-container |
| 14 | disposable cartridge |
| 16 | digital microfluidics system |
| 18 | first substrate |
| 20 | central control unit |
| 22 | electrode |
| 24 | array of electrodes |
| 26 | first hydrophobic surface |
| 28 | second hydrophobic surface |
| 30 | gap |
| 32 | micro-container interface |
| 34 | cone |
| 36 | nozzle |
| 37 | working film |
| 38 | fluidic access hole |
| 39 | clamping means |
| 40 | spacer |
| 42 | gasket |
| 44 | tube |
| 46 | piston |
| 48 | liquid |
| 50 | first gripping portion |
| 52 | second gripping portion |
| 54 | manifold |
| 56 | micro-container receptacle |
| 58 | groove |
| 60 | clip |
| 62 | releasing lever |
| 64 | recess |
| 66 | protrusion |
| 68 | ledge |
| 70 | linear array of caps |
| 72 | support |
| 74 | cap |
| 76 | cone |
| 78 | latch |
| 80 | trough |
| 82 | feeding connection |
| 84 | outlet connection |
| 86 | mechanical actuator |
| 88 | latch |
| D | diameter |

What is claimed is:

1. A cover (10) for use in a digital microfluidics system (16) for manipulating samples in liquid portions or droplets; the digital microfluidics system (16) comprising a first substrate (18) and a central control unit (20), wherein said first substrate (18) comprises an array of electrodes (24), and wherein said central control unit (20) is in operative connection to said electrodes for controlling the selection of individual electrodes (22) thereof and for providing a number of said electrodes with voltage for manipulating liquid portions or droplets by electrowetting; in said digital microfluidics system (16), a working gap (30) with a gap height is located parallel to the array of electrodes (24) and in-between first and second hydrophobic surfaces (26,28); the two hydrophobic surfaces (26,28) facing each other at least during operation of the digital microfluidics system (16),
wherein the cover (10) comprises on one side the second hydrophobic surface (28) and on another side at least one micro-container interface (32) for safe introducing into and/or withdrawing of liquids from the gap (30); said at least one micro-container interface (32) comprising at least one cone (34), the inner surface thereof being formed such to provide a sealing form fit contact with an outer surface of an inserted micro-container nozzle (36), by which a liquid (48) is transferrable through a fluidic access hole (38) formed into the cover (10) and interconnecting each cone (34) and the gap (30).

2. The cover (10) of claim 1,
wherein the cover (10) and said first and second hydrophobic surfaces (26,28) are comprised by a disposable cartridge (14) configured to be positioned on the array of electrodes (24) of the first substrate (18).

3. The cover (10) of claim 2,
wherein the disposable cartridge (14) comprises a working film (37) with the first hydrophobic surface (26) and the cover (10) comprises the second hydrophobic surface (28), the second hydrophobic surface (28) being separated or separable from said first hydrophobic surface (26) by said gap (30), said working film (37) comprising a backside that is configured to touch an uppermost surface of the first substrate (18) of the digital microfluidics system (16).

4. The cover (10) of claim 3,
wherein the cover (10) of the disposable cartridge (14) is configured rigid or flexible; at least one spacer (40) being attached to the cover (10), thus sealingly enclosing the gap (30), defining the height of the gap (30) between the first and second hydrophobic surfaces (26,28) of the disposable cartridge (14), and permanently separating the first and second hydrophobic surfaces (26,28).

5. The cover (10) of claim 3,
wherein the cover (10) of the disposable cartridge (14) is configured rigid and the working film (37) of the disposable cartridge (14) is configured flexible; at least one gasket (42) being attached to the cover (10) and outside of the gap (30) for separating said first and second hydrophobic surfaces (26,28) when creating an underpressure between the backside of the working film (37) and the uppermost surface of the first substrate (18) of the digital microfluidics system (16).

6. The cover (10) of claim 1,
wherein said first hydrophobic surface (26) is irremovably comprised by said first substrate (18) and the second hydrophobic surface (28) is comprised by said cover (10) that is configured as a rigid plate and to be accommodated on the first substrate (18).

7. The cover (10) of claim 6,
wherein the cover (10) or the first substrate (18) comprises a spacer (40) for separating said first and second hydrophobic surfaces (26,28) when accommodating the cover (10) on the first substrate (18) of the digital microfluidics system (16).

8. The cover (10) of claim 1,
wherein said first hydrophobic surface (26) is comprised by a working film (37) that is reversibly placeable on said first substrate (18) and the second hydrophobic surface (28) is comprised by said cover (10) that is configured as a rigid plate and to be accommodated on the working film (37).

9. The cover (10) of claim 8,
wherein the cover (10) or the working film (37) comprise a spacer (40) for separating said first and second hydrophobic surfaces (26,28) when accommodating the cover (10) on the working film (37) which is placed on said first substrate (18) of the digital microfluidics system (16).

10. A micro-container (12) for use in a digital microfluidics system (16) for manipulating samples in liquid portions or droplets,
wherein the micro-container (12) comprises a tube (44), a nozzle (36) with an aperture, and a piston (46) sealingly guided inside the tube (44) for dispensing or aspirating liquid (48) via the nozzle (36) of the micro-container (12),
and wherein the outer surface of the nozzle (36) of the micro-container (12) is formed such to provide a sealing form fit contact with an inner surface of a cone (34) comprised by a micro-container interface (32) of a cover (10) according to claim 1.

11. The micro-container (12) of claim 10,
wherein the micro-container (12) is pre-filled with a liquid (48) selected form the group comprising reagents, oil, buffers, and samples.

12. The micro-container (12) of claim 10,
wherein the micro-container (12) is adapted to transfer a sample to the digital microfluidics system (16), said sample being selected from the group comprising blood, saliva, urine, and feces.

13. The micro-container (12) of claim 10,
wherein the diameter of the aperture of the nozzle (36) of the micro-container (12) is ≦1 mm, preferably ≦0.5 mm.

14. The micro-container (12) of claim 10,
wherein an outer surface of the tube (44) of the micro-container (12) is provided with a first gripping portion (50).

15. The micro-container (12) of claim 14,
wherein a distal end of the piston (46) is provided with a second gripping portion (52).

16. The micro-container (12) of claim 15,
wherein the first and second gripping portions (50,52) comprise an outer rim projecting radially from the outer surfaces of the tube (44) and piston (46), respectively.

17. The micro-container (12) of claim 16,
wherein the micro-container (12) is adapted to be loaded into a manifold (54).

18. The micro-container (12) of claim 17,
wherein the first gripping portion (50) is formed such to be received in a groove (58) formed into the manifold (54) such to releasably couple the micro-container (12) to the manifold (54) at least in an axial direction of the micro-container (12).

19. The micro-container (12) of claim 18,
wherein at least one rim part of the first gripping portion (50) is formed planar and aligned with planar portions of the manifold (54) in a region adjacent to the loaded micro-container (12).

20. A manifold (54) comprising at least one micro-container receptacle (56) adapted to accommodate a micro-container (12) according to claim 10.

21. The manifold (54) of claim 20,
wherein the manifold (54) comprises a plurality of elongated micro-container receptacles (56) aligned to each other in parallel.

22. The manifold (54) of claim 20,
wherein each receptacle (56) comprises a groove (58) adapted to receive a first gripping portion (50) radially protruding from a micro-container (12) tube.

23. The manifold (54) of claim 22,
wherein the manifold (54) is adapted to receive a clip (60) attachable to the manifold (54) such to engage a planar rim part of the first gripping portion (50) of at least one micro-container (12) received in the receptacles (56).

24. The manifold (54) of claim 23,
wherein the attachment of the clip (60) to the manifold (54) at least on one side of the clip (60) is a snap-fit connection.

25. The manifold (54) of claim 20,
wherein the manifold (54) is adapted to receive at least one cap (74) attachable to the manifold (54) at a bottom side thereof, the at least one cap (74) being formed such to sealingly engage a nozzle (36) of a micro-container (12) received in the manifold (54).

26. The manifold (54) of claim 25,
wherein the manifold (54) is adapted to receive a linear array of caps (70) attachable to the manifold (54) at a bottom side thereof, the caps (74) being formed such to each sealingly engage a nozzle (36) of a micro-container (12) received in the manifold (54).

27. The manifold (54) of claim 25,
wherein each of the caps (74) comprises a cone (76), wherein the inner surface thereof is formed such to provide a sealing form fit contact with an outer surface of nozzles (36) of micro-containers (12) received in the manifold (54) if the caps (74) are attached to the manifold (54).

28. The manifold (54) of claim 25,
wherein each cap (74) is mounted on a support (72), the support (72) comprising snap-fit connections for releasable attachment of the support (72) to the manifold (54) and for temporary sealing form fit contact with an outer surface of nozzles (36) of micro-containers (12) received in the manifold (54) if the caps (74) are attached to the manifold (54).

29. The manifold (54) of claim 20,
wherein the manifold (54) is adapted to be received in a trough (80) capable of keeping a reagent filled into the at least on micro-container (12) accommodated in the manifold (54) at a specific temperature.

30. The manifold (54) of claim 29,
wherein the trough (80) comprises feeding and outlet connections (82,84) for applying to and withdrawing a tempering liquid from the trough (80) into which a part of the micro-containers (12) accommodated in the manifold (54) are reaching.

31. A method of introducing liquid (48) into a gap (30) of a digital microfluidics system (16) for manipulating samples in liquid portions or droplets; the digital microfluidics system (16) comprising a first substrate (18) and a central control unit (20), wherein said first substrate (18) comprises an array of electrodes (24), and wherein said central control unit (20) is in operative connection to said electrodes for controlling the selection of individual electrodes (22) thereof and for providing a number of said electrodes with voltage for manipulating liquid portions or droplets by electrowetting; in said digital microfluidics system (16), a working gap (30) with a gap height is located parallel to the array of electrodes (24) and in-between first and second hydrophobic surfaces (26,28); the two hydrophobic surfaces (26,28) facing each other at least during operation of the digital microfluidics system (16),
wherein the method comprises the steps of:
(a) placing a cover (10) on the first substrate (18) of the digital microfluidics system (16), the cover (10) comprising on one side the second hydrophobic surface (28) and on another side at least one micro-container interface (32); said at least one micro-container interface (32) comprising at least one cone (34) with an inner surface and at least one fluidic access hole (38) formed into the cover (10) and interconnecting each cone (34) and the gap (30);
(b) providing an essentially uniform height of the gap (30) between said first and second hydrophobic surfaces (26,28);
(c) inserting a nozzle (36) of at least one micro-container (12) filled with liquid (48) into at least one cone (34) of the micro-container interface (32) of the cover (10),
(d) creating a sealing form fit contact between the inner surface of the at least one cone (34) of the micro-container interface (32) and an outer surface of the nozzle (36) of the inserted at least one micro-container (12); and
(e) dispensing liquid (48) from the at least one micro-container (12) into the gap (30) via the at least one fluidic access hole (38) formed in the cover (10).

32. The method of claim 31, further comprising the step of clamping the placed cover (10) on the first substrate (18) by means of at least one clamping means (39) of the digital microfluidics system (16).

33. The method of claim 31, the cover (10) being comprised by a disposable cartridge (14), the disposable cartridge (14) comprising a working film (37) with the first hydrophobic surface (26) and the cover (10) comprising the second hydrophobic surface (28), the cover (10) of the disposable cartridge (14) being configured rigid or flexible, at least one spacer (40) being attached to the cover (10), the second hydrophobic surface (28) being separated or separable from said first hydrophobic surface (26) by said gap (30), said working film (37) comprising a backside that is configured to touch an uppermost surface of the first substrate (18) of the digital microfluidics system (16),
wherein the method further comprises the steps of:
(f) sealingly enclosing the gap (30) with the spacer (40);
(g) defining with the spacer (40) the height of the gap (30) between the first and second hydrophobic surfaces (26,28) of the disposable cartridge (14), and permanently separating the first and second hydrophobic surfaces (26,28); and
(h) positioning the disposable cartridge (14) on the array of electrodes (24) of the first substrate (18) of the digital microfluidics system (16).

34. The method of claim 31, the cover (10) being comprised by a disposable cartridge (14), the disposable cartridge (14) comprising a working film (37) with the first hydrophobic surface (26) and the cover (10) comprising the second hydrophobic surface (28), the cover (10) of the disposable cartridge (14) being configured rigid and the working film (37) of the disposable cartridge (14) being configured flexible; at least one gasket (42) being attached to the cover (10) and outside of the gap (30) for separating said first and second hydrophobic surfaces (26,28),
wherein the method further comprises the steps of:
(f) positioning the disposable cartridge (14) on the array of electrodes (24) of the first substrate (18) of the digital microfluidics system (16);
(g) creating an underpressure between the backside of the working film (37) and the uppermost surface of the first substrate (18) of the digital microfluidics system (16); and
(h) spreading the working film (37) on the first substrate (18) of the digital microfluidics system (16) and establish the gap height.

35. The method of claim 31, said first hydrophobic surface (26) being irremovably comprised by said first substrate (18) and the second hydrophobic surface (28) being comprised by said cover (10) that is configured as a rigid plate,
wherein the method further comprises the steps of:
(f) accommodating the cover (10) on the first substrate (18); and
(g) separating said first and second hydrophobic surfaces (26,28) by a spacer (40) that is separately provided or that is comprised by the cover (10) or by the first substrate (18) of the digital microfluidics system (16).

36. The method of claim 31, said first hydrophobic surface (26) being comprised by a working film (37) that is reversibly placeable on said first substrate (18) and the second hydrophobic surface (28) being comprised by said cover (10) that is configured as a rigid plate,
wherein the method further comprises the steps of:
(f) placing the working film (37) on the first substrate (18) of the digital microfluidics system (16);
(g) accommodating the cover (10) on the first substrate (18); and
(h) separating said first and second hydrophobic surfaces (26,28) by a spacer (40) that is separately provided or that is comprised by the cover (10) or by the working film (37).

37. The method of claim 31,
wherein the micro-container (12) is loaded into a manifold (54) that is then reversibly attached to the cover (10).

38. The method of claim 31,
wherein a sample is transferred into the gap (30) of the digital microfluidics system (16) utilizing the micro-container (12) adapted therefor, said sample being selected from the group comprising blood, saliva, urine, and feces.

39. A method of withdrawing liquid (48) from a gap (30) of a digital microfluidics system (16) for manipulating samples in liquid portions or droplets, the digital microfluidics system (16) comprising a first substrate (18) and a central control unit (20), wherein said first substrate (18) comprises an array of electrodes (24), and wherein said central control unit (20) is in operative connection to said electrodes for controlling the selection of individual electrodes (22) thereof and for providing a number of said electrodes with voltage for manipulating liquid portions or droplets by electrowetting; in said digital microfluidics system (16), a working gap (30) with a gap height is located parallel to the array of electrodes (24) and in-between first and second hydrophobic surfaces (26,28); the two hydrophobic surfaces (26,28) facing each other at least during operation of the digital microfluidics system (16),
wherein the method comprises the steps of:
(a) placing a cover (10) on the first substrate (18) of the digital microfluidics system (16), the cover (10) comprising on one side the second hydrophobic surface (28) and on another side at least one micro-container interface (32); said at least one micro-container interface (32) comprising at least one cone (34) with an inner surface and at least one fluidic access hole (38) formed into the cover (10) and interconnecting each cone (34) and the gap (30);
(b) providing an essentially uniform height of the gap (30) between said first and second hydrophobic surfaces (26,28);
(c) inserting the nozzle (36) of at least one micro-container (12) into at least one cone (34) of the micro-container interface (32) of the cover (10),
(d) creating a sealing form fit contact between the inner surface of the at least one cone (34) of the micro-container interface (32) and an outer surface of the nozzle (36) of the inserted at least one micro-container (12); and
(e) aspirating liquid from the gap (30) into the at least one micro-container (12) via the at least one fluidic access hole (38) formed into the cover (10).

40. The method of claim 39, the cover (10) being comprised by a disposable cartridge (14), the disposable cartridge (14) comprising a working film (37) with the first hydrophobic surface (26) and the cover (10) comprising the second hydrophobic surface (28), the cover (10) of the disposable cartridge (14) being configured rigid or flexible, at least one spacer (40) being attached to the cover (10), the second hydrophobic surface (28) being separated or separable from said first hydrophobic surface (26) by said gap (30), said working film (37) comprising a backside that is configured to touch an uppermost surface of the first substrate (18) of the digital microfluidics system (16),
wherein the method further comprises the steps of:
(f) sealingly enclosing the gap (30) with the spacer (40);
(g) defining with the spacer (40) the height of the gap (30) between the first and second hydrophobic surfaces (26,28) of the disposable cartridge, and permanently separating the first and second hydrophobic surfaces (26,28); and
(h) positioning the disposable cartridge (14) on the array of electrodes (24) of the first substrate (18) of the digital microfluidics system (16).

41. The method of claim 39, the cover (10) being comprised by a disposable cartridge (14), the disposable cartridge (14) comprising a working film (37) with the first hydrophobic surface (26) and the cover (10) comprising the second hydrophobic surface (28), the cover (10) of the disposable cartridge (14) being configured rigid and the working film (37) of the disposable cartridge (14) being configured flexible; at least one gasket (42) being attached to the cover (10) and outside of the gap (30) for separating said first and second hydrophobic surfaces (26,28),
wherein the method further comprises the steps of:
(f) positioning the disposable cartridge (14) on the array of electrodes (24) of the first substrate (18) of the digital microfluidics system (16);
(g) creating an underpressure between the backside of the working film (37) and the uppermost surface of the first substrate (18) of the digital microfluidics system (16); and
(h) spreading the working film (37) on the first substrate (18) of the digital microfluidics system (16) and establishing the gap height.

42. The method of claim 39, said first hydrophobic surface (26) being irremovably comprised by said first substrate (18) and the second hydrophobic surface (28) being comprised by said cover (10) that is configured as a rigid plate,
wherein the method further comprises the steps of:
(f) accommodating the cover (10) on the first substrate (18); and
(g) separating said first and second hydrophobic surfaces (26,28) by a spacer (40) that is separately provided or that is comprised by the cover (10) or by the first substrate (18) of the digital microfluidics system (16).

43. The method of claim 39, said first hydrophobic surface (26) being comprised by a working film (37) that is reversibly placeable on said first substrate (18) and the second hydrophobic surface (28) being comprised by said cover (10) that is configured as a rigid plate,
wherein the method further comprises the steps of:
(f) placing the working film (37) on the first substrate (18) of the digital microfluidics system (16);
(g) accommodating the cover (10) on the first substrate (18); and
(h) separating said first and second hydrophobic surfaces (26,28) by a spacer (40) that is separately provided or that is comprised by the cover (10) or by the working film (37).
